(19) United States
(12) Patent Application Publication
(10) Pub. No.: US 2026/0024751 A1
(43) Pub. Date: Jan. 22, 2026

(54) METHOD FOR PRODUCING SILICON ELECTRODES AS ANODES FOR LITHIUM ION BATTERIES AND A SILICON ELECTRODE PRODUCED USING SAME

(71) Applicant: NORCSI GMBH, Halle (DE)

(72) Inventors: Udo REICHMANN, Wilsdruff (DE); Andreas KRAUSE-BADER, Dresden (DE); Marcel NEUBERT, Kreischa (DE)

(73) Assignee: NORCSI GMBH, Halle (DE)

(21) Appl. No.: 18/876,493

(22) PCT Filed: Feb. 8, 2023
(86) PCT No.: PCT/EP2023/053062

§ 371 Date: Dec. 18, 2024

(30) Foreign Application Priority Data
Jun. 20, 2022 (DE) 10 2022 115 232.4

(51) Int. Cl. H01M 4/1395; H01M 4/02; H01M 4/04; H01M 4/134; H01M 4/36; H01M 4/38; H01M 4/66; H01M 10/0525; H01M 10/42

(52) U.S. Cl. CPC H01M 4/1395; H01M 4/0404; H01M 4/0471; H01M 4/134; H01M 4/364; H01M 4/386; H01M 4/661; H01M 10/0525; H01M 10/4235; H01M 2004/021; H01M 2004/027

(57) ABSTRACT

The invention relates to a method for producing a silicon electrode as an anode for a lithium ion battery, in which an active layer is deposited on a substrate, preferably copper, and then undergoes a rapid tempering, as well as an anode produced using same. The object of the invention of providing a method, which dispenses with the need for a vacuum section for depositing the active material, in particular silicon, for the production of anodes for lithium ion batteries, and thereby allows for an extremely cost-optimised production of almost pure silicon anodes for lithium ion batteries, is achieved in that the active layer is formed from a silicon and metal particle mixture, which is applied to the substrate in a dry process and stabilised in a controlled manner via the rapid tempering to form a semi-porous active layer and fixed to the substrate.

The invention relates to a method for producing a silicon electrode as anode for a lithium-ion battery, wherein an active layer is deposited on a substrate, preferably copper, and is subsequently subjected to accelerated annealing.

The invention likewise relates to an anode which is suitable for use in a lithium-ion battery and is produced by the method as claimed in claims 1 to 10.

Electrochemical energy storage is a vital cornerstone in the global efforts toward energy transition, serving to provide interim storage of the fluctuating power generated by regenerative means and to make it available for static and mobile applications. Mitigating against raw materials-based scarcity and hence increase in costs for secondary batteries in particular requires not only the diversification of the energy storage concepts, but also new materials. These materials ought both to improve the technical performance of such energy storage concepts (including capacity, energy density, lifetime) and to minimize the costs of nuchemical elements, as represented by silicon, for which a broad technology basis already exists.

Batteries are electrochemical energy stores and are differentiated as primary and secondary batteries.

Primary batteries are electrochemical power sources in which chemical energy is converted irreversibly into electrical energy. A primary battery is therefore not rechargeable. Secondary batteries, also called accumulators, on the other hand, are rechargeable electrochemical energy stores in which the chemical reaction that takes place is reversible, enabling multiple use. During charging, electrical energy is converted into chemical energy, and on discharge it is converted back from chemical to electrical energy.

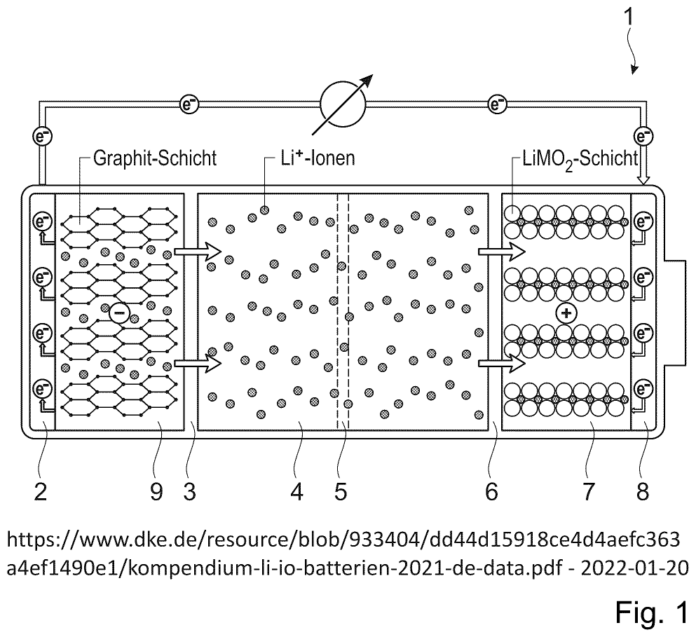

Battery is the umbrella term for interconnected cells. Cells are galvanic units which consist of two electrodes, electrolyte, separator, and cell casing. FIG. 1 shows an illustrative construction and the function of a lithium-ion cell during discharging. The constituents of a cell are briefly elucidated below.

Each Li-ion cell consists of two different electrodes 7, 9: an electrode 7, which is negatively charged in the charged state, and an electrode 9, which is positively charged in the charged state. Since release of energy, in other words discharge, is accompanied by migration of ions from the negatively charged electrode to the positively charged electrode, the positively charged electrode is called cathode 7 and the negatively charged electrode is called anode 9. The electrodes are each composed of a current collector 2, 8 (also called collector) and of an active material applied thereon. Located between the electrodes are firstly the ion-conducting electrolyte 4, which enables the required exchange of charge, and the separator 5, which ensures the electrical separation of the electrodes.

The cathode consists, for example, of mixed oxides applied on an aluminum collector. Transition metal oxides with cobalt (Co), manganese (Mn) and nickel (Ni) or aluminum oxide (Al₂O₃) are the most common compounds here. The applied metal oxide layer serves for intercalation of the lithium ions during discharge of the cell.

The anode of the Li-ion cell may consist of a copper foil as collector and of a layer of carbon as active material. The carbon compound used is usually natural or synthetic graphite, as it possesses a low electrode potential and exhibits little volume expansion during charging and discharging. During charging, lithium ions are reduced and intercalated into the graphite layers.

In constructions for lithium-ion batteries, the cathode typically supplies the lithium atoms for charging and discharge in the anode, and hence the battery capacity is limited by the cathode capacity. As already mentioned, typical cathode materials used to date are, for example, Li(Ni,Co,Mn)O₂ and LiFePO₄. Because of the construction of the cathode by lithium metal oxides, possibilities for boosting the capacity are minimal.

Also known for use with Li battery anodes is silicon rather than carbon. Silicon as an anode material has a high storage capacity of 3579 mAh/g at room temperature, as compared with the conventional carbon-type materials, such as graphite with a storage capacity of 372 mAh/g, for example. Challenges arise with the use of silicon as anode material, however, in terms of the sometimes considerable change in volume (volume contraction and expansion) during the intercalation and deintercalation of the mobile ion species during charging and discharge of corresponding energy stores. For graphite, the change in volume on lithium intercalation is around 10%, whereas for silicon it is up to 400%. The change in volume of the anode material when silicon is used leads to internal stresses, cracking, pulverization of the active material (silicon), loss of electrical contact, and ultimately to complete destruction of the anode.

Commonplace methods for the large-scale industrial production of silicon-containing anodes for lithium-ion batteries make use of silicon powders or silicon particles, which are applied to copper current collectors in slurries with carbon-containing binders in wet or dry roll-to-roll processes. By slurries are meant mixtures of solid substances, the solids being dispersed in a liquid. With the slurry-based processes, a layer of silicon particles with a carbon-containing binder is calendered or applied to a current collector. The binder ensures adhesion and electrical contact between the particles and to the current collector. In the majority of cases, the process requires a drying section, in which solvents deleterious to further processing are driven out. Advantages of these slurry-based methods are the high scalability of the processes, the adjustment of the capacity of the anodes thus produced through the applied layer thickness, and the simple and favorable supplying of active material by external processes. Disadvantages of these slurry-based methods are the usually expensive starting materials, such as ultra-pure silicon, powders of defined particle size, carbon binders, and other non-active constituents, homogeneity and porosity, etc., and the energy costs of the drying section required. The slurries typically employ nanoscale silicon particles, so as to compensate the applied stress when the active layers expand during lithiation in the lithium-ion battery. The principal causes of the failure of structures produced in this way for lithium-ion batteries, more particularly the loss of capacity of the lithium-ion batteries, are the electrical contact loss of the Si structures and the loss of electrolyte at the large surface area of the active layer.

It is additionally known that there are new methods which use virtually 100% pure silicon as anode material to enable maximum storage capacity. Loose or pulverulent nanoscale starting materials are unsuitable for producing electrical contact to the current collector, as they are not fixed on the current collector. Active layers composed 100% of silicon can only be produced, according to the present state of the art, using vacuum processes. Here, silicon is applied to prestructured surfaces so as to enable nanostructuring of the Si structures, referred to as columnar structures, and to produce sufficient adhesion. This is typically done using a PECVD process or sputter process (in this regard, see also: 1. Markevich, E. et al. Amorphous Columnar Silicon Anodes for Advanced High Voltage Lithium Ion Full Cells: Dominant Factors Governing Cycling Performance. J. Electrochem. Soc. 160, A1824 (2013); 2. Piwko, M. et al. Hierarchical columnar silicon anode structures for high energy density lithium sulfur batteries. Journal of Power Sources 351, 183-191 (2017). 3. Ravi Chandran, K. S. & Palmer, J. A critical review and assessment of 3D columnar silicon electrode architectures and their performance as negative electrodes in Li-ion cells. Materials Science and Engineering: B 271, 115278 (2021); 4. Haro, M. et al. Nano-vault architecture mitigates stress in silicon-based anodes for lithium-ion batteries. Commun Mater 2, 1-10 (2021) or 5. Schlaier, J. et al. Electrochemical Patterning of Cu Current Collectors: An Enabler for Pure Silicon Anodes in High-Energy Lithium-Ion Batteries. Advanced Materials Interfaces n/a, 2200507.

In optimized processes, the disadvantages of a slurry-based construction of a silicon anode have been circumvented by applying the active material or the structure of the anode for a lithium-ion battery in planar fashion, as a stratum, in a vacuum facility by means of PVD methods, such as sputtering or vaporization. An innovative process which includes accelerated annealing allows the active material to be stabilized and fixed on the current collector. This has made it possible to avoid the removal of unnecessary constituents in the process chain, such as the solvent in the slurries or residues of binder constituents. The utilization of PVD deposition methods, however, harbors other disadvantages, such as a high energy requirement to operate a vacuum section to allow the application to the current collector of a high layer thickness which is unusual for PVD methods.

The object of the present invention is therefore to specify a method which does away with the need to utilize a vacuum section to deposit the active material, particularly silicon, to produce anodes for lithium-ion batteries, and which therefore enables extremely cost-optimized manufacture of virtually pure silicon anodes for lithium-ion batteries. Furthermore, the production method is to be capable of simple integration into existing roll-to-roll methods with slurry-based production of the layers; that is, it is to replace the slurry-based binders while nevertheless ensuring sufficient current contact both among one another and to the current collector.

The object of the invention is achieved by a method in accordance with independent method claim 1.

In the method for producing a silicon electrode as anode for a lithium-ion battery, wherein an active layer is deposited on a substrate, preferably copper, and is subsequently subjected to accelerated annealing, the active layer is formed from a silicon and metal particle mixture which is applied to the substrate in a dry process and, under control by the accelerated annealing, is stabilized to form a semi-porous active layer and fixed on the substrate.

By a dry process is meant a water- and solvent-free process, for example cathodic atomization (sputtering). The material of the active layer is introduced into the process in the form of a particle layer in the size order up to the layer thickness used. In other words, the sizes of the particles in the silicon and metal particle mixture are situated in the size order of the layer thickness to be constructed for the active layer. To increase conductivity, the silicon active material, present preferably in powder form, is combined beforehand in the desired proportions with metal powder in particle sizes of similar size order, and then fixed on the substrate and among one another by an accelerated annealing procedure. In contrast to existing methods, the reaction between the silicon and the copper substrate and between the silicon particles and the metal particles is controlled by the ultra-short energy input of the accelerated annealing, so making it possible to prevent a complete reaction and hence a loss of active material. The parameters of the accelerated annealing should be established so as to enable a reaction of active material, i.e., the silicon particles, with the metal particles.

In one configuration of the method of the invention, the silicon and metal particle mixture is carbon-free.

By a carbon-free mixture is meant that the weight fraction of carbon in the silicon and metal particle mixture is below 0.1% by weight.

Oxidized surfaces and carbon in and on the active layer to be deposited pose a particular hindrance to a successful reaction between the silicon particles and metal particles, and must be removed sufficiently before the accelerated annealing. This is accomplished, for example, by wet-chemical etching or in the form of a dry vacuum process in a reductive plasma, for example Ar/H₂.

In a further configuration of the method of the invention, the particles of the silicon and metal particle mixture are in the size order of the layer thickness to be applied for the active layer of the anode, the active layer of the anode being deposited with a layer thickness of 1 to 30 μm. A preferred average size of the silicon particles and of the metal particles, measured along a direction of the greatest extent, is situated in the range between 100 nm and 10 μm.

A goal of the method of the invention is the production of a semi-porous layer having an active layer thickness between 1 to 30 μm that possesses high electrical conductivity and also very good fixing on the current collector. The conductivity is adjusted by the fraction of metal particles in the active layer. For an active layer porosity of 50%, i.e., a density ratio of cavity volume to total volume of the active layer material of 1:1, and a specific capacity of 50% of the ideal capacity, i.e., 25% of the active layer is reacted with Cu, 25% of the active layer is contacted only insufficiently, and for an active layer thickness of 30 μm, an overall capacity of 4.5 mAh/cm² is realizable. For an active layer porosity of 25% and a fraction of 10% of the active layer reacted with Cu, overall capacities in the same size order can be realized at an active layer thickness of just 15 μm. This is achievable without further ado by way of the method of the invention.

In a different further configuration of the method of the invention, the silicon particles are amorphous, with the silicon particles having a size distribution of d10≤100 nm, d50≤5 μm, d90≤10 μm. The d[number] figure corresponds to a percentile of a particle distribution function, thus meaning that in the case of d10, for example, 10% of all the particles have a particle size of less than or equal to 100 nm. The average particle size is measured along a direction of the greatest extent of the silicon particles. The d50 figure is also called the median. In accordance with the invention, the median ought to be less than or equal to 5 μm. d90 means that 90% of all the Si particles have a size of less than or equal to 10 μm.

The use of amorphous silicon particles is preferential since it lowers the initial energy input in the first charging cycle for a lithium-ion battery with an anode produced by the method of the invention and since no energy need be expended for disruption of the silicon crystal structure.

In one configuration of the method of the invention, the metal particles are formed from one of the materials copper (Cu), nickel (Ni), manganese (Mn), cobalt (Co), iron (Fe), aluminum (Al), titanium (Ti), magnesium (Mg), silver (Ag), gold (Au) and/or tin (Sn) and/or a mixture of these materials.

The insertion of an additional material or metal into the active layer has the advantage that on the one hand, the copper of the copper substrate reacts only in a very small proportion with the applied layers, so ensuring good adhesion in particular, and that on the other hand, the copper of the current collector is not degraded, owing to the suppression of a reaction with the further layers deposited.

Furthermore, a semi-porous active layer of high conductivity is generated thereby. The active layer is capable of withstanding the volume expansion that accompanies lithium intercalation.

In a further configuration of the method of the invention, the accelerated annealing is a flash-lamp annealing and is carried out by means of a flash lamp having a flash lamp duration in the range from 0.2 to 20 ms and an energy density in the range from 0.6 to 160 J/cm² and/or with preheating or cooling in the range from 4° C. to 200° C.

In a different further configuration of the method of the invention, the accelerated annealing is a laser annealing and is carried out by means of a laser with an annealing time in the range from 0.01 to 100 ms by the establishment of a rate of scanning of a local heating site and an energy density in the range from 0.1 to 100 J/cm² and/or with preheating or cooling in the range from 4° C. to 200° C.

The statement of the temperature range from 4° C. to 200° C. is the surface temperature of the substrate or of the layer to be annealed.

Accelerated annealing refers in particular to flash-lamp annealing and/or laser annealing. Flash-lamp annealing takes place with a pulse duration or annealing time in the range from 0.3 to 20 ms and a pulse energy in the range from 0.3 to 100 J/cm². In the case of laser annealing, the annealing time of 0.01 to 100 ms is established through the rate of scanning of the local heating site, to generate an energy density of 0.1 to 100 J/cm². The heating ramps achieved in the accelerated annealing are situated in the range, necessary for the method, of 10\hat{ }4-10\hat{ }7 K/s. Flash-lamp annealing for this purpose utilizes a spectrum in the visible wavelength range, whereas for laser annealing, discrete wavelengths in the range of the infrared (IR) to ultraviolet (UV) spectrum are used.

It has emerged that the effect of the accelerated annealing differs for the deposition of different materials in the active layer. The cause of this is considered to be the wide variety of different chemical events in connection with silicon, particularly the temperature of alloy formation, which is evident in the corresponding phase diagrams. As a result, different structures can be formed in the anode layer generated, for example column structures in the case of nickel. Furthermore, different silicides may be formed, which intercalate lithium as well in contrast to Cu silicides, whose capacity to intercalate lithium is negligible or zero. The advantage of exploiting the stated differences is that it can be used to control the volume expansion of silicon on intercalation of lithium. As a result, the stability of battery operation is significantly enhanced.

In the case of titanium, a Ti silicide is formed for example, which in the correct phase may have Li intercalation capacity (see: Xu, J. et al. Preparation of TiSi₂ Powders with Enhanced Lithium-Ion Storage via Chemical Oven Self-Propagating High-Temperature Synthesis. Nanomaterials 11, 2279 (2021)). This has the advantage that there is no clear boundary between Li-active and Li-inactive and consequently there is good electrical contact even during cycling. Further metals such as aluminum, for example, do not form any compound with silicon, that is, do not form any silicides. As a consequence of this, these metals mix in silicon and the electrical conductivity is increased. In the accelerated annealing step, there may additionally be improvements in the morphology and hardness of the silicon-metal layer relative to the hard pure silicon.

The reactions compelled by the accelerated annealing between the silicon particles and the metal particles are non-equilibrium processes, which are realizable only in the ms range and therefore necessitate the use of a flash lamp or a laser.

The aforesaid reaction is enabled through the defined input of energy by means of accelerated annealing of one or more strata of particles. In this case there is a sufficient reaction between metal and silicon, without the silicon reacting completely and without insufficient active material remaining. More metal denotes more reaction opportunities but less active material. More energy denotes more adhesion but less active material. An optimal outcome is dependent on the particle sizes and materials used.

In one configuration of the method of the invention, a protective layer, preferably a carbon layer and/or one or more strata of an artificial solid electrolyte interphase (SEI), is deposited on the active layer. The thickness of the protective layer is 10-20 nm for the carbon layer.

The surface of the deposited active layer may subsequently be post-functionalized, through the application, for example, of a carbon layer or of a so-called artificial SEI by standard methods, e.g. in a vacuum or inert gas process, such as an ALD (atomic layer deposition) process. A vacuum facility is only still required for the cleaning of the surface of the particles and maybe for surface modification, if necessary. Consequently, the cost and complexity become minimal, since on the one hand all of the starting materials are in a dry state and on the other hand the actual deposition of the layers under vacuum is dispensed with. It is advantageous for the artificial SEI to be formed from Al₂O₃, TiO₂, SiO₂ and/or LiOH, since these prevent further oxidation and are nevertheless sufficiently pervious to Li+ ions during battery operation. The thickness of the artificial SEI is between 2-20 nm.

In contrast to similar structures such as silicon nanowires or columnar structures, the method of the invention avoids vacuum processes as far as possible, and also cost-intensive drying sections for slurry-based processes. Consequently, fabrication with minimal usage of materials and minimal process costs is possible and can be integrated into existing roll-to-roll facilities.

In a different configuration of the method of the invention, the parameters of the accelerated annealing are adjusted as a function of the size of the particles of the silicon and metal particle mixture, of a mixing ratio of the silicon and metal particle mixture, and of the deposited layer thickness.

Depending on particle size of the silicon and of the added metal or of the added metals, the mixing ratio of silicon and metal(s), and the layer thickness of the active layer, an optimum energy input can be established through choice of the parameters of the accelerated annealing. The accelerated annealing takes place after a deposited stratum of the active layer. A stratum therefore refers to a deposited layer of active material which is subsequently subjected to accelerated annealing; depending on the stratum thickness, the active layer of the electrode may be composed of one or more strata.

In one configuration of the method of the invention, the substrate before the deposition of the silicon and metal particle mixture and/or the contact faces between the silicon particles and metal particles are cleaned.

For the reaction of the metals with the silicon particles, a clean contact face between the silicon particles/metal particles and between silicon particles/substrate must be ensured. This can be achieved by suitable, readily removable protective layers or by reductive upstream processes for surface cleaning, e.g., H₂-containing plasmas. A further possibility exists through the production of clean surfaces on application of the active layer, for example on spray phase deposition, where particles are applied at high velocity to the substrate, where they fracture. The fracture edges are then suitable for the reaction.

In a further configuration of the method of the invention, the particles of the silicon and metal particle mixture are heated by the accelerated annealing in such a way that a reaction of not more than 25% of the active material with the substrate takes place and therefore a high strength of adhesion between the active material and the copper substrate is ensured.

This configuration of the method makes it possible in an advantageous way to further enhance the stability of the structures without the need to use separately produced framework structures, composed of copper silicides, on which (amorphous) silicon is retrospectively applied, as described for example in Collins, G. A., Kilian, S., Geancy, H. & Ryan, K. M. A Nanowire Nest Structure Comprising Copper Silicide and Silicon Nanowires for Lithium-Ion Battery Anodes with High Areal Loading. Small 2021, 7, 2102333 or Song, H. et al. Highly Connected Silicon-Copper Alloy Mixture Nanotubes as High-Rate and Durable Anode Materials for Lithium-Ion Batteries. Advanced Functional Materials 26, 524-531 (2016). Where clean contacting is present between the particles and/or nanostructures with one another and to the current collector, which have been produced typically in a vacuum method by means of PVD or CVD, they are heated by the accelerated annealing to an extent such that there is a partial reaction of not more than 25% of the active material with the copper substrate and hence a significantly increased strength of adhesion is ensured.

In a different further configuration of the method of the invention, further strata of active material are deposited on the active material for increasing capacity of the anode with high stability and electrical conductivity.

In particular, further particles of the silicon and metal particle mixture may be deposited on the surface of the particle structures and nanostructures produced in a vacuum method by means of PVD or CVD, so as to realize an anode of increased capacity with high stability and electrical conductivity. It may be necessary to clean the surface again, by means of a reductive plasma, for example.

The object of the invention is likewise achieved by an anode in accordance with independent arrangement claim 13.

An anode suitable for use in a lithium-ion battery and produced by the method as claimed in claims 1 to 12 comprises a current collector, preferably composed of copper, and an active layer deposited on the current collector, the active layer being formed of a silicon and metal particle mixture which is applied to the substrate in a dry process and, under control by an accelerated annealing, is stabilized to form a semi-porous active layer and fixed on the substrate.

By a dry process is meant a water- and solvent-free process, for example cathodic atomization (sputtering).

In one configuration of the anode of the invention, the metal particles are formed of one of the materials copper (Cu), nickel (Ni), manganese (Mn), cobalt (Co), iron (Fe), aluminum (Al), titanium (Ti), magnesium (Mg), silver (Ag), gold (Au) and/or tin (Sn) and/or a mixture of these materials.

In a different configuration of the anode of the invention, the active layer of the anode has a layer thickness of 1 to 30 μm.

In a further different configuration of the anode of the invention, the substrate is embodied as a copper lattice, the active layer being applied to the copper lattice.

Relative to a sheetlike copper substrate, the copper lattice has open regions. The silicon/metal particle mixture, i.e., the powder mixture, is incorporated into this copper lattice and then subjected to accelerated annealing. This allows the weight of the current collector to be significantly reduced. The conductivity of the active layer, however, must be high enough to allow this arrangement to be employed as an anode.

In a further configuration of the anode of the invention, the substrate is embodied as a sacrificial substrate, the active layer being applied to the sacrificial substrate and subjected to accelerated annealing, the sacrificial substrate being removed, and the active layer having a specific electrical conductivity of greater than 1*10⁴ S/cm and the active layer being contactable from one side.

If the specific electrical conductivity of the active layer is greater than 1*10⁴ S/cm, an anode can be realized even without a current collector. The active layer composed of the silicon/metal particle mixture is first applied to a sacrificial substrate and subjected to accelerated annealing. The sacrificial substrate is then removed and the active layer is contacted directly, at the side of the active layer for example.

The invention likewise encompasses a metal particle mixture for producing an anode as claimed in claims 15 to 17 using a method as claimed in claims 1 to 12, the metal particle mixture having a size distribution of d10=100 nm, d50=3 μm, d90=5 μm. The d[number] figure corresponds to a percentile of a particle distribution function, thus meaning that in the case of d10, for example, 10% of all the metal particles have a particle size of less than or equal to 100 nm. The average particle size is measured along a direction of the greatest extent of the silicon particles. The d50 figure is also called the median. In accordance with the invention, the median of the metal particle mixture ought to be less than or equal to 3 μm. d90 means that 90% of all the metal particles have a size of less than or equal to 5 μm.

The invention is to be elucidated in more detail below with reference to exemplary embodiments.

The content of the drawings is as follows:

FIG. 1 Illustrative construction and function of a lithium-ion cell during discharging;

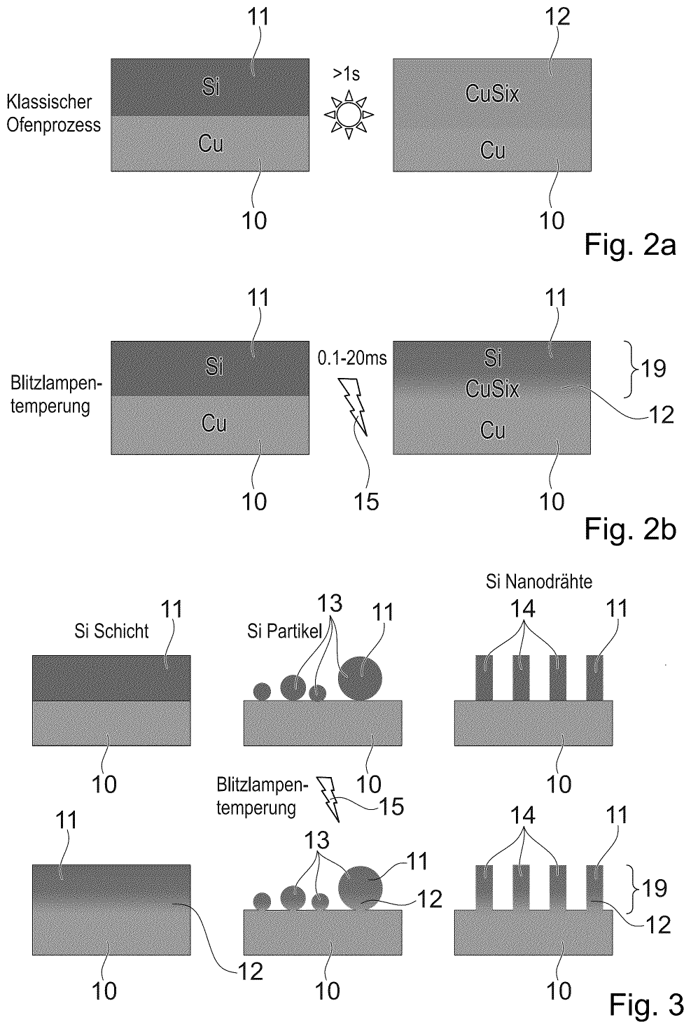

FIG. 2 Influence of a temperature input on silicide formation in a silicon anode a) in a conventional oven process (prior art) b) with accelerated annealing, especially flash-lamp annealing;

FIG. 3 Schematic representation of different silicon variants on a copper substrate and the influence of accelerated annealing on the copper silicides that form;

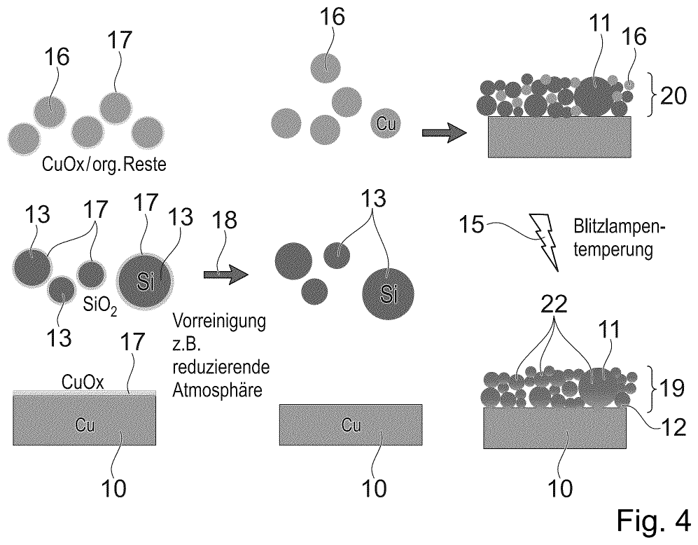

FIG. 4 Schematic representation of a silicon and metal particle mixture on a copper substrate and the influence of accelerated annealing;

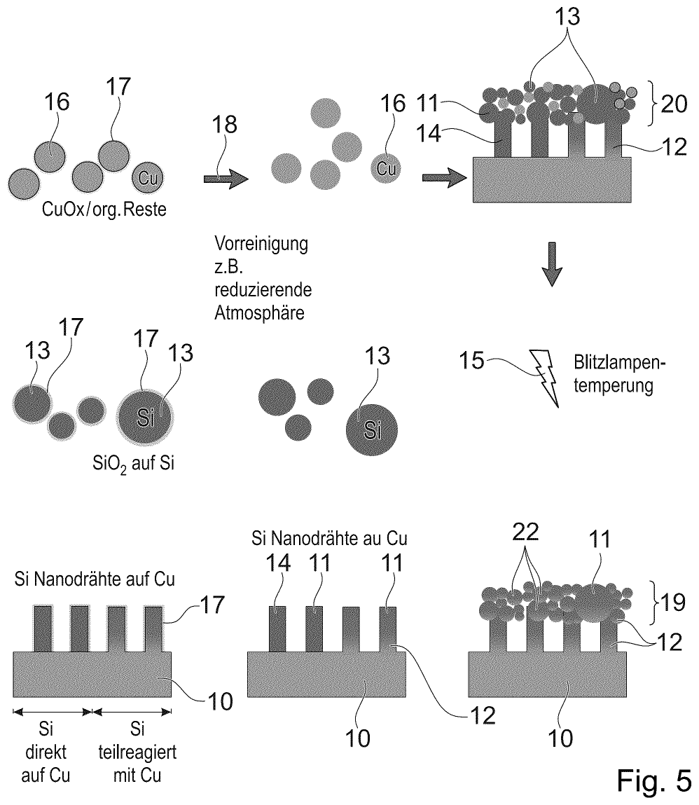

FIG. 5 Schematic representation of a preprocessed substrate surface on which a silicon and metal particle mixture is deposited and subjected to accelerated annealing;

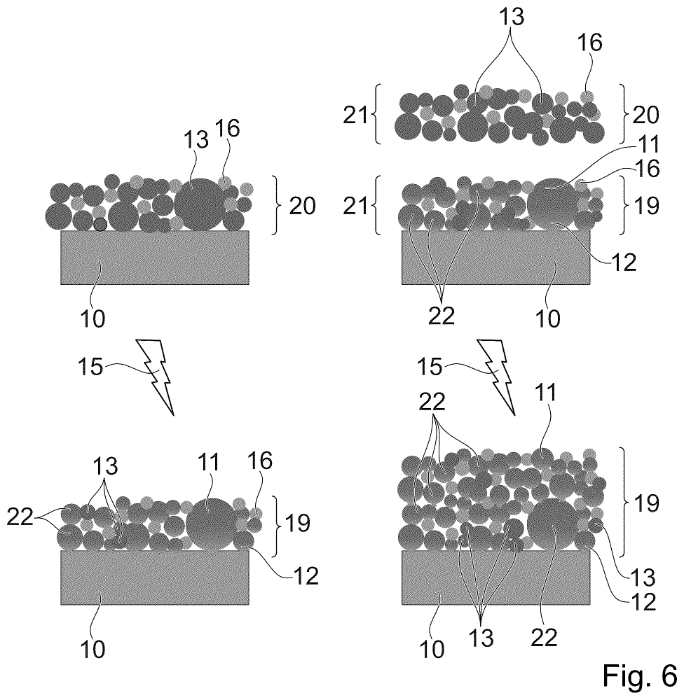

FIG. 6 Schematic representation of a partially reacted active layer of the anode of the invention composed of Si and Cu particles.

The diffusion of metals into silicon and the reaction of silicon with metals are heavily time- and temperature-dependent. At very low temperatures, from 200° C. onward, many metals 16 form a metal silicide 12 at the border of contact between metal 16 and silicon 11, this silicide possessing a capacity, no capacity or only a very slight capacity for reversible lithium intercalation. Metals 16 diffuse even at room temperature and very rapidly at elevated temperature, and the diffusion is difficult to control in conventional oven processes. Taking copper as an example, a complete layer of silicon has undergone reaction after no later than 1 s at 600° C. (see FIG. 2a).

FIG. 2b) shows the influence of accelerated annealing 15, more particularly flash-lamp annealing, on the formation of silicide 12 at the contact location in a layer system composed of copper 10 and silicon 11. Owing to the very short flash pulse in the range from 0.1 to 10 ms, the reaction of the silicon 11 with the copper 10 to form copper silicide 12 is incomplete. As a result of the flash-lamp annealing 15, pure amorphous or nanocrystalline silicon 11 remains, and is available as active material for lithium intercalation; at the same time, there are a sufficient quantity of inactive regions which ensure stability and good electrical conductivity.

FIG. 3 shows different variants of silicon structures applied to a copper substrate 10—as a homogeneous layer, as silicon particles 13 or as silicon nanowires 14. Accelerated annealing 15, such as flash-lamp annealing, for example, leads to a controlled local reaction of the silicon 11 with the copper 10 to form copper silicide 12 at their point of boundary contact. As a result, the silicon is joined en masse with the substrate. The schematic representation shows a linear profile from pure copper 10 through copper silicide 12 to silicon 11; a realistic transition is substantially inhomogeneous in profile; the boundary is much more roughened, to the point of formations of Cu/CuSiₓ dentrides into the silicon. Dentrides are bushy or treelike crystal structures.

FIG. 4 shows the schematic representation of a silicon and metal particle mixture 20 on a copper substrate 10 and the influence of accelerated annealing 15. Silicon particles 13 are calendered together with metal particles 16, preferably copper as powder, on a copper foil 10. This is followed by accelerated annealing 15, flash-lamp annealing for example, with the silicon particles 13 adhering on the substrate 10 and among one another as a result of the metal particles 16, Cu particles in the example. The reaction requires clean contact of the surfaces, since oxides or organic residues prevent the desired reaction. Pretreatment with, for example, a reducing atmosphere may be useful for this purpose. The result is a binder-free, dry process for the powder processing of Si particles 13 with high conductivity, increased porosity and excellent adhesion between the active layer 19 and the substrate 10. The Si particles 13 and the metal particles 16 form partially reacted particles 22 composed of Cu/CuSiₓ/Si.

In a further exemplary embodiment in accordance with FIG. 5, the copper substrate 10 may have been preprocessed with silicon nanowires 14, for example. Silicon particles 13 are calendered together with metal particles 16, preferably copper as powder, on a copper foil 10, with both the copper substrate surface 10 and the powder mixture 20 being cleaned 18 by means of a reducing atmosphere, for example. The silicon and metal particle mixture 20 and the substrate are subjected to accelerated annealing 15, a flash-lamp annealing for example, with the adhesion being realized through the reaction of the silicon particles 13 with the metal particles 16, more particularly copper in the exemplary embodiment, to form partially reacted particles 22.

In a further exemplary embodiment, an anode for a lithium-ion battery is produced by the method of the invention (see FIG. 6). First a suitable silicon/metal particle mixture 20 is produced, and is applied to a copper substrate 10 which constitutes the later current collector of the electrode. The deposited powder mixture 20 is subjected to accelerated annealing 15. The accelerated annealing 15 may be flash-lamp annealing or laser annealing. The accelerated annealing 15 produces a partially reacted active layer 19 of silicon-metal particles 20, which is fixed on the current collector 10.

The accelerated annealing 15 allows targeted control of the input of energy into the deposited layer. An optimal energy input can be established according to particle size, mixing ratio, and layer thickness. As a result of the defined energy input by means of flash-lamp annealing 15, for example, after a stratum 21 of particles 20, there is a sufficient reaction between/in the metal-silicon mixture 20, without the silicon 11 reacting completely; in other words, pure Si particles are left, or active material remains only insufficiently. More metal 16 denotes more reaction opportunities but less active material. More energy denotes more adhesion on the current collector 10 and/or between the particles 13, 16, but less active material. Partially reacted particles composed of Cu/CuSiₓ/Si 22 are formed. An optimal outcome is dependent on the particle sizes and the materials used. Insufficiently reacted or enclosed Si particles 13 do not adhere and so can be easily removed. Subsequently, the application of the particle mixture 20 and the accelerated annealing 15 may be carried out again.

Following the deposition and annealing of the active layer 19 deposited by means, for example, of sputtering, the application of a protective layer or artificial SEI is possible, including in vacuum processes, as there is no need for drying.

An advantage of the method of the invention is that silicon 11 in powder form with high scatter of the particle size 13 and high impurity level can be used as base material and hence is correspondingly cost-effective. Relatively small silicon particles 13 enable a multi-stratum 21 construction and hence easier adjustment of the capacity of the overall layer of the anode. Amorphous silicon particles 13 are preferred, as in that case the initial input of energy in the first charging cycle is smaller and there is no need to expend energy when disrupting the Si crystal structure.

In contrast to existing slurry methods, carbon as a binder is a hindrance in technical process terms, as with the method of the invention it has emerged that even extremely thin carbon strata of up to 5 nm can prevent a satisfactory reaction between Si particles.

### LIST OF REFERENCE SIGNS

1 lithium-ion battery
2 collector on anode side
3 SEI-solid-electrolyte interphase
4 electrolyte
5 separator
6 conducting interphase
7 cathode, positive electrode
8 collector on cathode side
9 anode, negative electrode
10 copper substrate
11 silicon
12 copper silicide; metal silicide; or boundary contact of the silicide reaction
13 silicon particles
14 silicon nanowires
15 accelerated annealing, e.g., flash-lamp annealing
16 copper particles; metal particles
17 copper oxide/organic residues; impurities
18 cleaning step
19 active layer
20 silicon and metal particle mixture
21 deposited stratum in the active layer
22 semi-reacted particles (e.g., Cu/CuSiₓ/Si)

1. A method for producing a silicon electrode as anode for a lithium-ion battery, wherein an active layer is deposited on a substrate, preferably copper, and is subsequently subjected to accelerated annealing, characterized in that the active layer is formed from a silicon and metal particle mixture which is applied to the substrate in a dry process and, under control by the accelerated annealing, is stabilized to form a semi-porous active layer and fixed on the substrate.

2. The method for producing a silicon electrode as anode for a lithium-ion battery as claimed in claim 1, wherein the silicon and metal particle mixture is carbon-free.

3. The method for producing a silicon electrode as anode for a lithium-ion battery as claimed in claim 1, wherein particles of the silicon and metal particle mixture are in the size order of the layer thickness to be applied for the active layer of the anode, the active layer of the anode being deposited with a layer thickness of 1 to 30 μm.

4. The method for producing a silicon electrode as anode for a lithium-ion battery as claimed in claim 1, wherein the silicon particles are amorphous, the Si particles having a size distribution of d10≤100 nm, d50≤5 μm, d90≤10 μm.

5. The method for producing a silicon electrode as anode for a lithium-ion battery as claimed in claim 1, wherein the metal particles are formed from one of the materials copper, Cu, nickel, Ni, manganese, Mn, cobalt, Co, iron, Fe, aluminum, Al, titanium, Ti, magnesium, Mg, silver, Ag, gold, Au, and/or tin, Sn, and/or a mixture of these materials.

6. The method for producing a silicon electrode as anode for a lithium-ion battery as claimed in claim 1, wherein the accelerated annealing is a flash-lamp annealing and is carried out by means of a flash lamp having a flash light duration in the range from 0.2 to 20 ms and an energy density in the range from 0.6 to 160 J/cm² and/or with preheating or cooling in the range from 4° C. to 200° C.

7. The method for producing a silicon electrode as anode for a lithium-ion battery as claimed in claim 1, wherein the accelerated annealing is a laser annealing and is carried out by means of a laser with an annealing time in the range from 0.01 to 100 ms by the establishment of a rate of scanning of a local heating site and an energy density in the range from 0.1 to 100 J/cm² and/or with preheating or cooling in the range from 4° C. to 200° C.

8. The method for producing a silicon electrode as anode for a lithium-ion battery as claimed in claim 1, wherein a protective layer, preferably a carbon layer and/or one or more strata of an artificial solid-electrolyte interphase, SEI, is deposited on the active layer.

9. The method for producing a silicon electrode as anode for a lithium-ion battery as claimed in claim 1, wherein the parameters of the accelerated annealing are adjusted as a function of the size of the particles of the silicon and metal particle mixture, of a mixing ratio of the silicon and metal particle mixture, and of the deposited layer thickness.

10. The method for producing a silicon electrode as anode for a lithium-ion battery as claimed in claim 1, wherein the substrate before the deposition of the silicon and metal particle mixture and/or contact faces between the silicon particles and metal particles are cleaned.

11. The method for producing a silicon electrode as anode for a lithium-ion battery as claimed in claim 1, wherein the particles of the silicon and metal particle mixture are heated by the accelerated annealing in such a way that a reaction of not more than 25% of the active material with the substrate takes place and therefore a high strength of adhesion between the active material and the substrate is ensured.

12. The method for producing a silicon electrode as anode for a lithium-ion battery as claimed in claim 11, wherein further strata of active material are deposited on the active material for increasing capacity of the anode with high stability and electrical conductivity.

13. An anode embodied and intended for use in a lithium-ion battery and produced by the method as claimed in claim 1, wherein the anode comprises a substrate as a current collector, preferably composed of copper, and an active layer deposited on the current collector, the active layer being formed from a silicon and metal particle mixture which is applied to the substrate in a dry process and, under control by an accelerated annealing, is stabilized to form a semi-porous active layer and fixed on the substrate.

14. The anode as claimed in claim 13, wherein the metal particles are formed of one of the materials copper, Cu, nickel, Ni, manganese, Mn, cobalt, Co, iron, Fe, aluminum, Al, titanium, Ti, magnesium, Mg, silver, Ag, gold, Au, and/or tin, Sn, and/or a mixture of these materials.

15. The anode as claimed in claim 13, wherein the active layer of the anode has a layer thickness of 1 to 30 μm.

16. The anode as claimed in claim 13, wherein the substrate is embodied as an open copper lattice, the active layer being applied on the open copper lattice.

17. The anode as claimed in claim 13, wherein the substrate is embodied as a sacrificial substrate, the active layer being applied to the sacrificial substrate and subjected to accelerated annealing, the sacrificial substrate being removed, and the active layer having a specific electrical conductivity of greater than 1*10⁴ S/cm and the active layer being contactable from one side.

18. A metal particle mixture for producing an anode as claimed in claim 15 using a method as claimed in claim 1, the metal particle mixture having a size distribution of d10=100 nm, d50=3 μm, d90=5 μm.
